(19) United States
(12) Patent Application Publication
(10) Pub. No.: US 2022/0222658 A1
(43) Pub. Date: Jul. 14, 2022

(54) CURRENCY VALUE MANAGEMENT SYSTEM AND CURRENCY VALUE MANAGEMENT PROGRAM

(71) Applicant: YUSHISOZO CO., LTD., Kanagawa (JP)

(72) Inventors: Kay DOMEN, Kanagawa (JP); Singi DOMEN, Kanagawa (JP); Ryoko DOMEN, Kanagawa (JP)

(21) Appl. No.: 17/612,798

(22) PCT Filed: May 20, 2020
(86) PCT No.: PCT/JP2020/019974

§ 371 Date: Nov. 19, 2021

(30) Foreign Application Priority Data
May 21, 2019 (JP) 2019-095428

(51) Int. Cl. G06Q 20/36

(52) U.S. Cl. CPC G06Q 20/3678

(57) ABSTRACT

The currency value management system includes a management server connected to a network. The management server has: an account management unit that manages an electronic main depository with which electronic information at least relating to currency values used for granting is associated, and grant object accounts with which electronic information relating to currency values of each grant object to which the currency values are granted from the electronic main depository is associated; a currency value granting unit that grants currency values as electronic information to a grant object account from the electronic main depository; and a currency value recovery unit that recovers a part of currency values as electronic information from the balance of currency values accumulated in the grant object account and transfers the part of currency values to the electronic main depository.

### TECHNICAL FIELD

The present disclosure relates to a currency value management system and a currency value management program.

### BACKGROUND

Bank deposits became electronic currencies that could be settled and transferred electronically when computers were introduced to banks and went online half a century ago. Currently, the Bank of Japan defines the money supply as “cash currencies+deposits deposited at deposit handling institutions”. That is, deposits are currencies and now occupy most of the currencies. A deposit is a digitized currency that exists only as a number on a deposit account, has the same unit (yen in Japan) as the legal tender currency, and can be settled and transferred electronically.

The construction of a financial system that accompanies the digitization of deposit currencies has dramatically increased the convenience of currency transfer and holding, and has promoted the subsequent development of financial engineering. Today, sophisticated networks of financial systems are spread all over the world, currencies instantly cross national borders, and huge amounts of financial transactions are carried out over a 24-hour period. As a result, the risky business of earning profit margin by speculation without creating added value has become popular, and a huge amount of financial products are being produced every day (see Non-Patent Document 1).

In such a financial system, electronically recorded property values with the same value as currencies such as virtual currencies and points have appeared in recent years. Various techniques have been considered to address the challenges of using such electronically recorded property values.

For example, Patent Document 1 discloses a method of collecting a transfer fee of an electronic value symbol without grasping the transfer information of each electronic value symbol. In addition, Patent Document 2 discloses a system using token that can smoothly and safely construct people's material consumption and entertainment enjoyment. In addition, Patent Document 3 discloses a settlement method of electronic money that can be expected to have an economic effect by psychologically promoting the consumption of electronic money in the electronic money system.

In addition, Non-Patent Document 2 discloses a means for stabilizing the total amount of currency in circulation by using “public money” issued by the government. In addition, in the efforts of Non-Patent Document 3, a means for suppressing the bubble economy and stabilizing the economy by using the same public money called sovereign money (not issued by a private bank) is disclosed. The common point in Non-Patent Document 2 and Non-Patent Document 3 is the suppression of the right of issuing currency by private banks, with the purpose of suppressing unlimited currency amount expansion and the loan economy.

In addition, Non-Patent Document 4 introduces the concept of “Gesell's free money” which depreciates over time. People compete to use it because it depreciates if left untreated. This was carried out in parts of Austria in the 1930s and proved to be very effective in revitalizing the economy. In addition, Non-Patent Document 5 introduces a depreciating currency called “Chiemgauer” that reproduced Gesell's free money with current electronic money.

The above electronic money and money have the concept of controlling the total amount of currency and the concept of depreciation that encourages the use of currency, but there is no compulsory circulation system. In addition, there is no concept that enables both total amount control and circulation of the currency.

### PRIOR ART REFERENCE

### Patent Document

Patent Document 1: Japanese Patent Application Publication No. 2001-202470

Patent Document 2: Japanese Patent Application Publication No. 2001-319170

Patent Document 3: International Publication 2004/036471

### Non-Patent Document

Non-Patent Document 1: Shingi Domen, Journal of Integrated Creative Studies, No.2018-005-a, 2018

[Non-Patent Document 2] Kaoru Yamaguchi, “Public Money”, Toyo Keizai Inc., 2015

[Non-Patent Document 3] Positive Money, [online], [Searched May 16, 1st year of Reiwa (2019)], internet <https://positivemoney.org/our-proposals/sovereign-money-introduction/>

[Non-Patent Document 4] Atsunori Kawamura, “Testament of Ende—that you ask the money from the source” Kodansha, 2011

[Non-Patent Document 5] Yasuyuki Hirota, “Theory of Depreciating Money”, Shuhirosha, 2013, [online] [Searched May 16, 1st year of Reiwa (2019)], internet <https://shukousha.com/column/hirota/2478/>

[Non-Patent Document 6] Thomas Piketty, “Capital in the Twenty-First Century”, Misuzu Shobo, 2014

[Non-Patent Document 7] Richard A. Werner, “Princes of the Yen”, Soshisha, 2001

[Non-Patent Document 8] Shingi Domen, “Illusion of Economics”, Kobunsha, 2005

[Non-Patent Document 9] David Orrell, Newsweek Japan Version 10.31, p.23, 2017

[Non-Patent Document 10] Shingi Domen, Journal of Integrated Creative Studies, No.2017-007-a, 2017

[Non-Patent Document 11] Nikkei News, 2018Nov. 13, “Government statistics, swaying in trust, distrust of the Bank of Japan such as GDP”, 2018, [online] [Searched May 16, 1st year of Reiwa (2019)], internet <https://www.nikkei.com/article/DGXMZ037675170S8A111C1EA1000/>

### SUMMARY

### Problems to be Solved

However, such a financial system has the following problems.

### <Problem 1: Stagnation and Precipitation of Currency>

In the monetary economy, the currency used in purchase and circulates in the market without disappearing. If this currency stagnates, precipitates and is maldistributed, economic disparity will occur. In modern times, currency stagnation, precipitation, and maldistribution have become prominent, and economic disparity and poverty are widening, as evidenced by Piketty's data (see Non-Patent Document 6).

However, in the current financial system, there is no mechanism to suppress the unlimited currency precipitation, and a forced circulation of currency from precipitation is not designed. This has led to unlimited currency precipitation in the wealthy class, increasing global economic disparity year by year.

FIG. 12 shows the relationship between the receipt or payment of interest from financial assets or liabilities and the amount of annual income. The plus on the vertical axis indicates net receipt, and the minus indicates payment.

This drawing shows the inflow and outflow of currencies for receiving and paying interest, etc., in the financial assets (deposits and savings and stocks) and liabilities (loans) of households, that is, the inflow and outflow of currencies other than annual income, by annual income class. In this figure, the plus on the vertical axis indicates that the currency is gained, and the minus indicates that the currency is lost. In addition, the size of the income and expenditure of other classes is represented by a relative ratio when the excess amount of receipt of the class with the highest annual income is set to 100.

From this figure, it can be seen that the class with the highest annual income gains the most currency, and that the annual income up to the eighth decile in the lower-level is on the contrary side that the currency is lost. In other words, it can be seen that those with high annual income receive income other than annual income from the financial system, while those with low annual income pay. The current financial system is redistributing currencies in the direction of further widening the economic disparity that originally existed in annual income.

Further, the following problems also arise in association with such a problem.

### <Problem 2: Impasse of Banking Business Conditions>

Currently, banks do not need to collect cash from others for lending, and can lend simply by writing numbers in the loanee account (see Non-Patent Document 7). This corresponds to creating an electronic currency called a deposit (see Non-Patent Document 8). This method is defined as “deposit creation”. When deposit creation is done, the amount of currency increases accordingly. In addition, when the loan is repaid to the deposit handling institution, the currency disappears and the currency of society decreases by the repayment amount. This is defined as “deposit disappearance”.

Since the deposit creation is nothing but the issuance of currency, it can be said that the deposit handling institution has the authority to issue currency effectively (see Non-Patent Document 1, Non-Patent Document 8, Non-Patent Document 2, and Non-Patent Document 9). Thereby, the deposit handling institution will no longer have to collect cash for lending, which will drastically reduce the cost of lending currencies.

On the other hand, now that the digitized currencies have become mainstream, and deposit handling institutions have come to play the role of guaranteeing and preserving electronic currencies called deposits. Therefore, these industries are currently equipment industries that have a large number of large-capacity servers and the like, IT industries that facilitate currency transfer and storage, and security industries that protect customers' currency in cyberspace. As a result of the need for such a large number of facilities and systems, the cost of deposits will increase for deposit handling institutions.

As described above, deposit handling institutions have the authority to create deposits and the function of preserving deposits due to the digitization of currencies, which has led to a drastic decrease in lending costs and an increase in deposit costs. However, currently, the structure is such that the loanees still pay interest, the depositors receive interest, and the loanees support the operation of the deposit handling institution including the deposit costs. This structure is the driving force to increase the number of loanees, and it is the root cause that unreasonable card loans for individuals have become a social problem (Non-Patent Document 1).

In present Japan, where the economy is mature, the willingness to invest in industry is not as great as it was during the period of high economic growth, and the companies are generally in the black with respect to banks because they are not active in requesting loans from banks. That is, in a bank, the amount of interest paid on a deposit is larger than the amount of interest earned from lending. This is also a factor in the development of the above-mentioned card loans for individuals. In order to prevent banks from becoming a driving force for unnecessary loan increase, it is essential to shift to a structure in which depositors bear the deposits costs.

### <Problem 3: Increase in Government's Budget Deficit>

Currently, it is the government that borrows the most from banks, and the government's budget deficit is increased. Originally, the currency that has been transferred to the private sector by the budget implementation of the government cannot be said to be sustainable finance unless a complete tax circulation is formed by returning to the government by tax collection. However, this has not been achieved. Designing a tax circulation is essential to improve the precarious day-to-day management in which more loans are taken for loan repayment.

### <Problem 4: Interest-Bearing Economy>

At present, the currency is issued by deposit creation and is precipitated in companies or wealthy class (see Non-Patent Document 1). This situation is shown in FIG. 13. The currency is issued when the government, companies and households borrow money from the deposit handling institution and is supplied to the real economy, but after circulating in society, most of the currency is precipitated in companies or wealthy class without circulation. For this reason, since the currency required for loan repayment is not circulated to the loanee, a further loan with an amount exceeding the original loan amount is required for interest-bearing repayment, Therefore, under the interest-bearing loan economy, loan increases continuously. Inflation is required to counteract this increase, but it cannot be said that the economy of continuously expanding loan and the inflation required to treat on it is sustainable. In order to eliminate this, it is essential to form an interest-free economy and a currency circulation.

### <Problem 5: Expansion of Unemployment Due to the Development of AI and Robots>

The industrial revolution at the end of the 19th century was a power revolution, which led to the explosive expansion of industry by enabling “work that humans cannot do.” However, currently, the intelligence revolution that allows machines to do “work that only humans could do” is underway, and there are concerns that machines will replace people's labor demands and unemployment will increase (see Non-Patent Document 10). Since the decrease in labor demands due to AI and robots originally should lead to an increase in leisure time, and it means that the goods and services that the whole nation can live in are available with a small amount of labor, it is a happy future. All the people have to do is to exchange a small amount of labor with currency.

In the monetary economy, currency was originally introduced as a “means” for exchange, and was a “public property” with the convenience of not having to carry heavy rice for exchange. However, at present, currency is “purposed” for saving money and is precipitated in the wealthy class as a “private property” (see Non-Patent Document 1).

For this reason, people are eagerly looking for new labor demands in order to obtain the currency that was originally introduced as a “means” for exchanging their labor. Despite the fact that the goods and services that the whole nation can live in are already available with a small amount of labor, introducing new unnecessary labor because of the lack of currency due to the precipitation is reversing the logical order of things, and is even harmful because it increases energy consumption and causes the global environment become exhausted.

In this problem as well, the currency precipitated in the wealthy class as a private property is a problem, and as long as the currency is sufficiently circulated and distributed to the whole nation as a public property, the decrease in labor demands should be able to lead to an increase in leisure time.

### <Problem 6: Inefficient Economic Measures>

Currently, various theories have been proposed regarding economic measures, and no reliable measures for economic boost have been proposed (see Non-Patent Document 1). Especially as the financialization of the world economy proceeds, the financial instability of one country may spread to the world, causing a chain of economic downturn. In current Japan, measures such as monetary easing of a different dimension are being implemented, but the effect of economic boost is limited (Non-Patent Document 10).

### <Problem 7: Lack of Easy Economic Effect Measurement Technology>

Since the numerical value of GDP varies greatly depending on the definition, it has been discussed among experts (see Non-Patent Document 11). An easy economic effect measurement method is indispensable for grasping the economic situation.

### <Problem 8: Economy Contraction Due to Deflation>

Japan is under long-term deflation, as symbolized by the phrase “lost twenty years”. Deflation causes the economy to contract because the prices of goods fall over time, which induces refraining from buying and causes stagnation of consumption. However, at present, with the development of science and technology improving productivity in all industries, prices are inevitably falling. Further, free competition in a market-based economy is promoting the fall in prices. The fall in prices is good for consumers, as long as they can consume actively, there are no disadvantage. It is necessary to take measures of promoting currency circulation that are effective even under deflation.

From the viewpoint of solving such problems, it is an object of the present disclosure to provide a currency value management system and a currency value management program that suppress unlimited stagnation, precipitation and maldistribution of currency values and smoothly circulate the currency values in the market.

### Means for Solving the Problems

An aspect of the present disclosure is a currency value management system that manages flow of currency values corresponding to monetary values, and includes a management server connected to a network.

The management server has: an account management unit that manages an electronic main depository with which electronic information at least relating to currency values used for granting is associated, and grant object accounts with which electronic information relating to currency values of each grant object to which the currency values are granted from the electronic main depository is associated; a currency value granting unit that grants currency values as electronic information to a grant object account from the electronic main depository; and a currency value recovery unit that recovers a part of currency values as electronic information from a balance of currency values accumulated in the grant object account and moves the part of currency values to the electronic main depository. In this system, the account management unit controls: grant of a predetermined amount of currency values as electronic information by the currency value granting unit upon a lapse of a predetermined grant period; and recovery of a predetermined amount of currency values as electronic information by the currency value recovery unit upon a lapse of a predetermined recovery period.

According to such a configuration, after a predetermined grant period elapses, a predetermined amount of currency values are granted to the user of the currency values as electronic information, so that the predetermined currency values can be supplied to the user as an investment in the life of the user. On the other hand, after a predetermined recovery period elapses, a predetermined amount of currency values with respect to the balance of the currency values are recovered as electronic information from the grant object account, so that it is possible to prevent the currency values from being continuously accumulated in the grant object account. Then, by repeating the grant and recovery of the currency values, the circulation of the currency values is promoted. Since the currency values are granted and recovered as electronic information, it is easy to grasp and control the flow of the currency values. In addition, as long as a program is created, the system will operate automatically, so the running cost is also low.

In the above-mentioned system, the account management unit further manages non-grant object accounts to which a predetermined amount of currency values are not granted as electronic information from the electronic main depository, and the currency value recovery unit, under the control of the account management unit, may recover a predetermined amount of currency values as electronic information from the balance of the currency values accumulated in each of the grant object accounts and the non-grant object accounts and transfer the predetermined amount of currency values to the electronic main depository. Thereby, accounts to which the currency values are not granted (non-grant object accounts) are set, and by allocating them to stores or the like, if the grant object uses the currency values at the stores, the circulation of the currency values can be further promoted.

The above-mentioned system further includes a terminal connected to the management server via a network. The terminal may have a currency value transfer instruction unit that sends at least any of the following instructions to the management server via the network: an instruction of transferring a predetermined amount of currency values as electronic information from one grant object account to another grant object account; an instruction of transferring a predetermined amount of currency values as electronic information from the grant object account to the non-grant object account; an instruction of transferring a predetermined amount of currency values as electronic information from the non-grant object account to the grant object account; and an instruction of transferring a predetermined amount of currency values as electronic information from one non-grant object account to another non-grant object account. Thereby, when a transaction is made between the grant objects and between the grant object and the non-grant object, it is possible to instruct the management server to transfer the currency values corresponding to the consideration of the transaction between the accounts via the network.

In the above-mentioned system, the account management unit may control at least any of: processing for transferring a predetermined amount of currency values as electronic information from one grant object account to another grant object account; processing for transferring a predetermined amount of currency values as electronic information from the grant object account to the non-grant object account; processing for transferring a predetermined amount of currency values as electronic information from the non-grant object account to the grant object account; and processing for transferring a predetermined amount of currency values as electronic information from one non-grant object account to another non-grant object account. Thereby, when a transaction is made between the grant objects and between the grant object and the non-grant object, it is possible to transfer the currency values corresponding to the consideration of the transaction between the accounts.

In the above-mentioned system, the recovery period may have the same number of days as that of the grant period, the date of grant by the currency value granting unit may be different from the date of recovery by the currency value recovery unit. Thereby, the grant and recovery of the currency values with respect to the user are performed on different days at regular intervals, and a cycle of the currency value circulation is constructed.

In the above-mentioned system, it is preferable that the grant by the currency value granting unit is performed at a fixed amount for each grant object account, and the recovery by the currency value recovery unit is performed at a fixed rate to the balance of the currency values accumulated in each account. Thereby, the currency values as an investment in the life of the user is regularly granted, and the currency values at a fixed rate to the balance of the currency values of each account is regularly recovered, which promotes the circulation of the currency values. Further, the grant is a fixed amount equal to all, and the recovery is a fixed rate according to the amount of currency values accumulated in each account, so that the currency values can be redistributed in the direction of eliminating the gap in the currency values holdings.

Another aspect of the present disclosure is a currency value management program that manages the flow of currency values corresponding to monetary values, performing in a computer steps of: an account management step of managing an electronic main depository with which electronic information at least relating to currency values used for granting is associated, and grant object accounts with which electronic information relating to currency values of each grant object to which the currency values are granted from the electronic main depository is associated; an currency value granting step of granting currency values as electronic information to a grant object account from the electronic main depository; a currency value recovery step of recovering a part of currency values as electronic information from a balance of currency values accumulated in the grant object account and transfers the part of currency values to the electronic main depository; and a granting and recovering step of performing grant of a predetermined amount of currency values as electronic information by a currency value granting unit upon a lapse of a predetermined grant period, and recovery of a predetermined amount of currency values as electronic information by a currency value recovery unit upon a lapse of a predetermined recovery period.

According to such a configuration, after a predetermined grant period elapses, a predetermined amount of currency values are granted to the user of the currency values as electronic information, so that currency values can be supplied to the user as an investment in the life. On the other hand, after a predetermined recovery period elapses, a predetermined amount of currency values with respect to the balance of the currency values are recovered as electronic information from the grant object account, so that it is possible to prevent the currency values from being continuously accumulated in the grant object account. Then, by repeating the grant and recovery of the currency values, the circulation of the currency values is promoted. Since the currency values are granted and recovered as electronic information, it is easy to grasp and control the flow of the currency values. Further, since the system operates automatically by the program, the running cost can be suppressed.

In the above-mentioned program, in the account management step, non-grant object accounts to which a predetermined amount of predetermined amount of currency values are not granted as electronic information from the electronic core repository may be further managed, and in the currency value recovery step, a predetermined amount of currency values may be recovered as electronic information from the balance of the currency values accumulated in each of the grant object accounts and the non-grant object accounts and transferred to the electronic main depository. Thereby, accounts to which currency values are not granted (non-grant object accounts) are set and by allocating them to a store or the like, the use of the currency values is promoted.

In the above-mentioned program, a management server and a terminal is connected via a network, and the computer may further perform a transfer instruction receiving step of receiving at least any of the following instructions via the network: an instruction of transferring a predetermined amount of currency values as electronic information from the consumer's grant object account to the supplier's grant object account; an instruction of transferring a predetermined amount of currency values as electronic information from the grant object account to the non-grant object account; an instruction of transferring a predetermined amount of currency values as electronic information from the non-grant object account to the grant object account; and an instruction of transferring a predetermined amount of currency values as electronic information from one non-grant object account to another non-grant object account. Thereby, when a transaction is made between the grant objects and between the grant object and the non-grant object, it is possible to transfer the currency values corresponding to the consideration of the transaction between the accounts via the network.

In the above-mentioned program, a currency value transfer step of performing at least any of the following processing may be further included: processing for transferring a predetermined amount of currency values as electronic information from one grant object account to another grant object account; processing for transferring a predetermined amount of currency values as electronic information from the grant object account to the non-grant object account; processing for transferring a predetermined amount of currency values as electronic information from the non-grant object account to the grant object account; and processing for transferring a predetermined amount of currency values as electronic information from one non-grant object account to another non-grant object account. Thereby, when a transaction is made between the grant objects and between the grant object and the non-grant object, it is possible to transfer the currency values corresponding to the consideration of the transaction between the accounts.

In the above-mentioned program, the recovery period may have the same number of days as that of the grant period, and the date of discovery by the currency value recovery step may be different from the date of grant by the currency value granting step. Thereby, the grant and recovery of the currency values with respect to the user are performed on different days at regular intervals, and a cycle of the currency value circulation is constructed.

In the above-mentioned program, it is preferable that the grant by the currency value granting step is performed at a fixed amount for each grant object account, and the recovery by the currency value recovery step is performed at a fixed rate to the balance of the currency values accumulated in each account. Thereby, the currency values as an investment in the life of the user is regularly granted, and the currency values at a fixed rate to the balance of the currency values of each account is regularly recovered and transferred to the electronic main depository, which promotes the circulation of the currency values. In addition, the grant is a fixed amount equal to all, and the recovery is a fixed rate according to the amount of currency values accumulated in each account, so that the currency values can be redistributed in the direction of eliminating the gap in the currency values holdings.

### Effects

According to the present disclosure, it is possible to provide a currency value management system and a currency value management program that suppress unlimited stagnation, precipitation and maldistribution of currency values and smoothly circulate the currency values in the market.

### BRIEF DESCRIPTION OF DRAWINGS

FIG. 1 is a schematic configuration diagram of a currency value management system according to the present embodiment;

FIG. 2(a) and FIG. 2(b) are block diagrams illustrating a hardware configuration of a server;

FIG. 3 is a functional block diagram of a currency value management system according to the present embodiment;

FIG. 4 is a flowchart illustrating a currency value management program according to the present embodiment;

FIG. 5 is a flowchart illustrating a currency value management program according to the present embodiment;

FIG. 6 is a flowchart showing a specific example of processing for granting and recovering currency values;

FIG. 7 is a conceptual diagram of accounts and flow of currency values;

FIG. 8 is a flowchart showing a specific example of processing in a transaction based on currency values;

FIG. 9 is a schematic diagram illustrating an image of accounts and points circulation;

FIG. 10(a) and FIG. 10(b) are schematic diagrams illustrating the establishment of an interest-free economy;

FIG. 11(a) and FIG. 11(b) are diagrams illustrating the asymptote of currency values;

FIG. 12 is a diagram showing the relationship between the receipt or payment of interest from financial assets or liabilities and the amount of annual income;

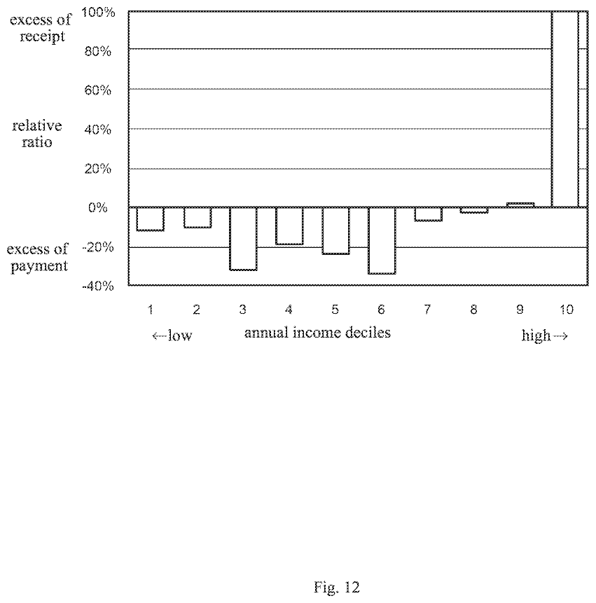

FIG. 13 is a diagram illustrating currency precipitation.

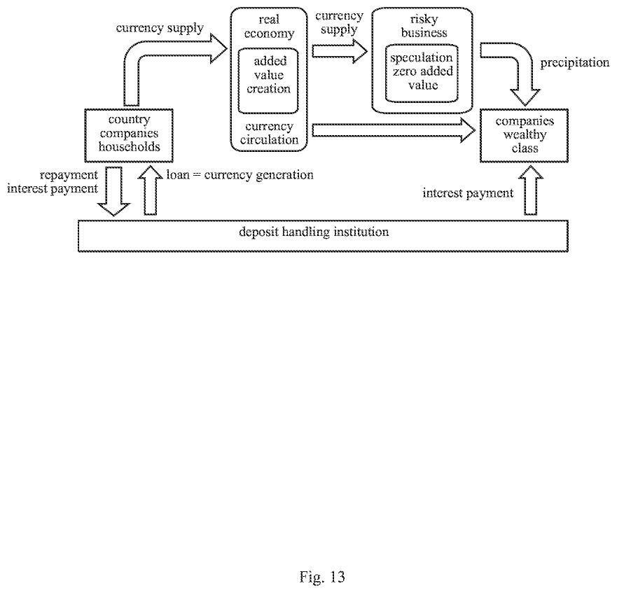

### DETAILED DESCRIPTION

Hereinafter, the embodiments of the present disclosure will be described based on the drawings. It should be noted that, in the following description, the same members are denoted by the same reference numerals, the member once explained will be omitted as appropriate.

### (Configuration of Currency Value Management System)

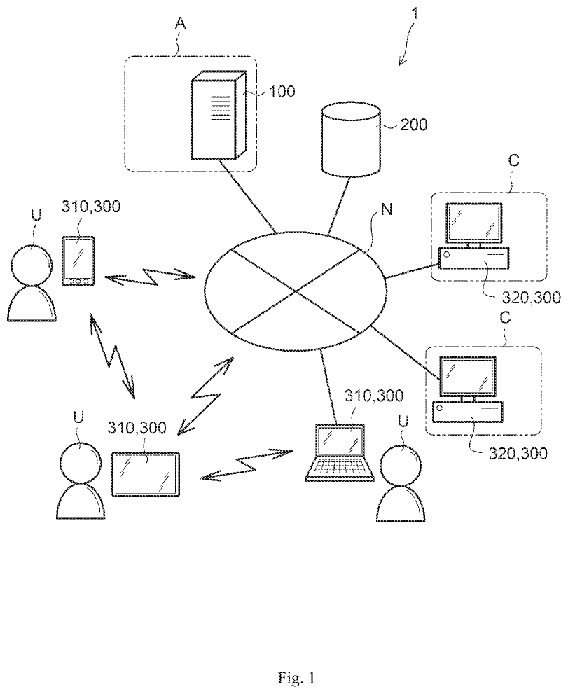

FIG. 1 is a schematic configuration diagram of a currency value management system according to the present embodiment.

The currency value management system 1 according to the present embodiment is a system that manages the flow of currency values corresponding to the monetary values. The currency value management system 1 may be applied in a specific region (country, municipality, between affiliated companies, etc.) or may be applied in a global range.

The terms used in the description of the present embodiment are defined as follows.

Currency value is a value corresponding to monetary value, and refers to a payment means that can be managed as electronic information as an alternative to cash, banknotes and deposits and savings.

User U refers to one (individual or corporation (public institution, organization, group, company, shop, etc.)) to which currency values are regularly granted. User U is also referred to as a grant object.

Cooperative institution C refers to one (corporation (public institution, organization, group, company, shop, etc.) and individual) to which currency values are not regularly granted. Cooperative institution C is also referred to as a non-grant object.

Management institution A refers to a manager/operator (bank, company, group, individual, public institution, etc.) that manages the flow of currency values.

Network N includes the internet, intranet, communication carrier lines, and the like. The communication method of the network N includes wireless and wired communication methods.

Terminal 300 refers to a device for the user U and the cooperative institution C to use the present system. The terminal 300 includes an individual terminal 310 handled by a user U, an employee or the like, and a transaction terminal 320 handled by a cooperative institution C.

Electronic main depository EM is an electronic safe with which electronic information relating to the currency values used for the currency circulation of grant and recovery is associated, and refers to a component that is the starting point of the currency value circulation.

User account AC-U refers to an account with which electronic information relating to currency values is associated for each user U.

General account AC-C refers to an account with which electronic information relating to currency values is associated for each cooperative institution C.

Employee account AC-W refers to an account with which electronic information relating to currency values is associated for each employee, etc. engaged in the cooperative institution C.

Bank account AC-B refers to an account with which electronic information relating to currency values is associated for each bank.

Grant object account refers to an account to which currency values are granted from the electronic main depository EM.

Non-grant object account refers to an account to which currency values are not granted from the electronic main depository EM.

The currency value management system 1 according to the present embodiment includes a management server 100 connected to the network N. The management server 100 is managed and operated by the management institution A or the like. A database server 200 and terminals 300(individual terminal 310 and transaction terminal 320) are connected to the network N. As the terminals 300, mobile terminals such as mobile phones, tablet terminals, and wearable terminals, personal computers, card-type terminals, and special purpose terminals can be mentioned. The terminals 300 have only an input/output function, and other functions such as a control function, a storage function, and a communication function are realized by other devices connected to the network N.

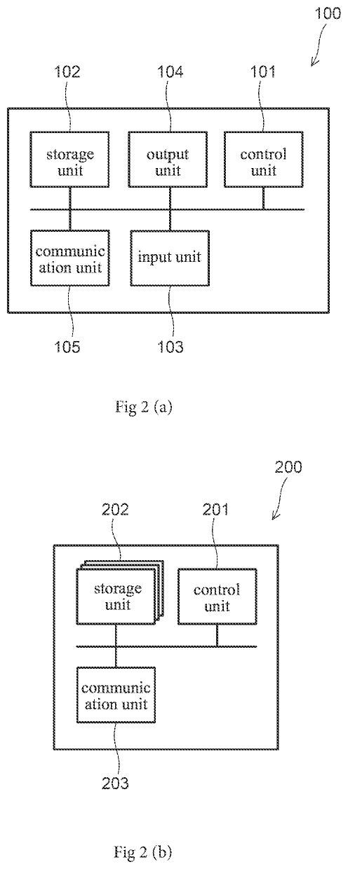

FIG. 2 shows block diagrams illustrating a hardware configuration of a server. FIG. 2(a) exemplifies the hardware configuration of the management server 100, and FIG. 2(b) exemplifies the hardware configuration of the database server 200.

As shown in FIG. 2(a), the management server 100 includes a control unit 101, a storage unit 102, an input unit 103, an output unit 104 and a communication unit 105. The currency value management program described later is executed in the control unit 101.

As shown in 2(b), the database server 200 includes a control unit 201, a storage unit 202 and a communication unit 203. The storage unit 202 stores account name information, electronic information relating to currency values, history information, and the like corresponding to various accounts described later.

Here, the database server 200 may be separated from the management server 100, or may be included in the management server 100. Further, the management server 100 may be separated from the database server 200, or may be included in the database server 200.

Further, the hardware configuration of each of the management server 100 and the database server 200 is not limited to that mentioned above.

Furthermore, the hardware configuration of each of the management server 100 and the database server 200 may be physically arranged in the same location (the same housing, the same building, the same area, the same country, etc.), or may be arranged discretely (the different housings, the different buildings, the different areas, the different countries, etc.) via the network N. In addition, it is not limited to one management server 100 and one database server 200, and may be configured by a plurality of management servers 100 and a plurality of database servers 200.

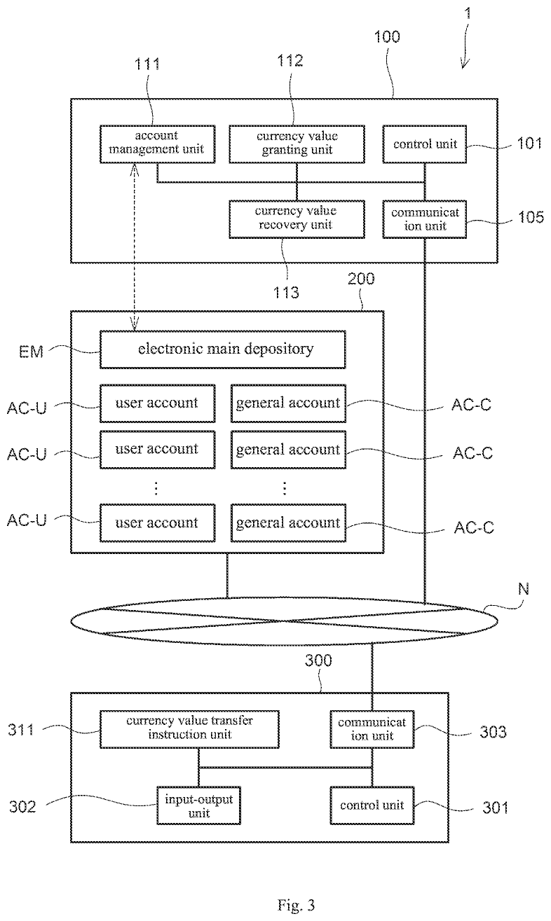

FIG. 3 is a functional block diagram of a currency value management system according to the present embodiment.

The management server 100 of the currency value management system 1 at least includes an account management unit 111, a currency value granting unit 112 and a currency value recovery unit 113 in addition to the control unit 101 and the communication unit 105.

The account management unit 111 manages user accounts AC-U with which the electronic information relating to the currency values of each user U is associated, and an electronic main depository EM with which the electronic information at least relating to the currency values used for granting is associated. In addition, the account management unit 111 may further manage general accounts AC-C with which a predetermined amount of currency values are not granted as electronic information from the currency value granting unit 112.

The currency value granting unit 112 performs processing for granting currency values as electronic information to the user account AC-U. That is, the currency value granting unit 112 receives an instruction from the account management unit 111 and executes processing for granting a predetermined amount of currency values as electronic information to the user account AC-U at a predetermined timing.

The currency value recovery unit 113 performs processing for recovering a part of the currency values as electronic information from the balance of the currency values accumulated in the user account AC-U and transferring the part of the currency values to the electronic main depository EM. That is, the currency value recovery unit 113 receives an instruction from the account management unit 111 and executes processing for recovering a part of the currency values as electronic information based on the balance of each user account AC-U of the user U at a predetermined timing and accumulating (collecting) the part of currency values in the electronic main depository EM.

In addition, when the general account AC-C is managed by the account management unit 111, the currency value recovery unit 113 received an instruction from the account management unit 111 and executes processing for recovering a part of the currency values as electronic information based on the balance from the general account AC-C as well as the user account AC-U at a predetermined timing and accumulating (collecting) the part of currency values in the electronic main depository EM.

The database server 200 stores information relating to user accounts AC-U, general accounts AC-C and electronic main depository EM. The user accounts AC-U are associated with each of a plurality of users U. The user account AC-U stores (manages by linking) the information relating to the registration information (registration date, personal information, etc.) of the user U, the balance of the currency values, the usage record of the currency values, and the like. The general account AC-C stores (manages by linking) the information relating to the registration information (registration date, individual information of companies, etc.) of the cooperative institution C, the balance of the currency values, the usage record of the currency values, and the like. The electronic main depository EM stores (manages by linking) the information relating to the balance of the recovered currency values, the history of recovery and grant of the currency values (history of recovery and grant associated with each account), and the like.

The terminal 300 includes at least a control unit 301, an input-output unit 302, a communication unit 303 and a currency value transfer instruction unit 311. The control unit 301 is a unit that controls each unit. The input-output unit 302 has an input unit such as a keyboard, a touch panel and a camera, and an output unit such as a display unit and a speaker. The communication unit 303 has an interface function with the network N.

The currency value transfer instruction unit 311 performs processing for sending an instruction (value transfer instruction) for transferring a predetermined amount of currency values as electronic information between the accounts to the management server 100 via the network N. Here, the following types of value transfer instructions can be mentioned.

(1)Instruction of transferring from one user account AC-U to another user account AC-U.

(2)Instruction to transfer from a user account AC-U to a general account AC-C.

(3)Instruction to transfer from a general account AC-C to a user account AC-U.

(4)Instruction to transfer from one general account AC-C to another general account AC-C.

It is to be noted that the above (1) is also an instruction to transfer from one grant object account to another grant object account, the above (2) is also an instruction to transfer from a grant object account to a non-grant object account, the above (3) is also an instruction to transfer from a non-grant object account to a grant object account, and the above (4) is also an instruction to transfer from one non-grant object account to another non-grant object account.

In the management server 100 that has received the value transfer instruction from the currency value transfer instruction unit 311, the processing is performed to transfer a predetermined amount of currency values as electronic information between the accounts in response to the value transfer instruction of any of the above (1) to (4) by the account management unit 111.

In the currency value management system 1 with such a configuration, the grant of a predetermined amount of currency values as electronic information by the currency value granting unit 112 upon a lapse of a predetermined grant period, and the recovery of a predetermined amount of currency values as electronic information by the currency value recovery unit 113 upon a lapse of a predetermined recovery period are controlled by the account management unit 111.

Thereby, when the predetermined grant period elapses, a predetermined amount of currency values are granted as electronic information to the user U of the currency values. Therefore, as the grant period elapses, the currency values are supplied to the user U as an investment in the life of the user U.

On the other hand, when the predetermined recovery period elapses, a predetermined amount of currency values with respect to the balance of the currency values are recovered as electronic information from the user account AC-U or the general account AC-C. That is, if the currency values remains in the user account AC-U or the general account AC-C at the stage when the recovery period has elapsed, the predetermined amount of currency values corresponding to the balance is forcibly collected. Therefore, it is possible to prevent the currency values from being accumulated (stagnated) indefinitely in the user account AC-U and the general account AC-C.

By such an account management unit 111, the grant and recovery of the currency values are set as one processing unit, and this processing unit is repeated in a predetermined cycle, so that the circulation of the currency values is promoted. Further, in the currency value management system 1 according to the present embodiment, since the currency values are granted and recovered as electronic information, it is easy to grasp and control the flow of the currency values. In addition, since it can be automated after the initial setting, the operation cost can be minimized.

Here, the recovery period may be set to the same number of days as the grant period, and the date of the recovery by the currency value recovery unit 113 may be different from the date of the grant by the currency value granting unit 112. For example, the grant of the currency values is performed on the 10th of every month, and the recovery of the currency values is performed at the end of every month. Thereby, the grant and recovery of the currency values is performed with respect to the user U on different days at regular intervals, and the cycle of the currency value circulation is constructed at regular intervals (for example, every month).

In addition, the grant by the currency value granting unit 112 may be performed for each user account AC-U at a fixed amount, and the recovery by the currency value recovery unit 113 may be performed at a fixed rate to the balance of the currency values accumulated in each account. Thereby, the currency values required by the user U is regularly granted, and at the same time, the currency values at a fixed rate to the balance of the currency values of each account, that is, the user account AC-U and the general account AC-C, is regularly recovered, which promotes a forced circulation of the currency values and the currency values are redistributed in the direction of reducing the gap in the holding amount of the currency values.

In addition, the recovery period may be set to a different number of days from the grant period. For example, one grant date may be set in a month, and multiple recovery dates may be set in a month. Thereby, the concentration of the currency values on the date of use can be eased. That is, with the setting of one grant date in a month and one recovery date in a month, it is easy to concentrate the use of currency values before the recovery date only once during a month. If multiple recovery dates are set in a month, the use of currency values will be dispersed during the month, and it will be easier to activate economic activities. On the contrary, multiple grant dates may be set in a month. Thereby, the planned use of currency values can be promoted.

### (Currency Value Management Program)

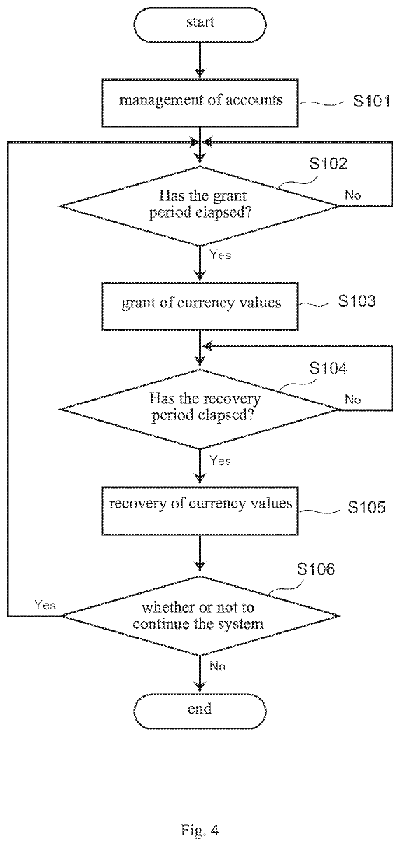

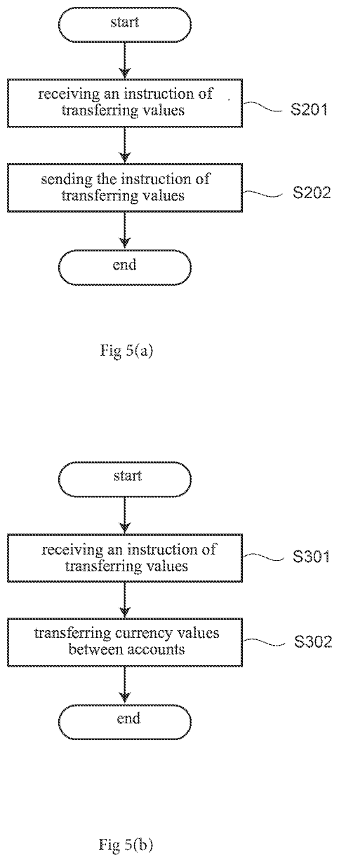

FIG. 4 and FIG. 5 are flowcharts illustrating a currency value management program according to the present embodiment.

The currency value management program according to the present embodiment causes a computer (typically, a management server 100) to execute the following steps.

<Account Management Step: Step S101 of FIG. 4>

The account management step executes processing for managing a user account AC-U with which the electronic information relating to the currency values of each user U is associated, and an electronic main depository EM with which the electronic information at least relating to the currency values used for granting is associated. The account management step may perform processing for further managing the general account AC-C with which a predetermined amount of currency values are not granted as electronic information in the currency value granting step.

<Currency Value Granting Step: Step S103 of FIG. 4>

The currency value granting step executes processing for granting currency values as electronic information to the user account AC-U.

<Currency Value Recovery Step: Step S105 of FIG. 4>

The currency value recovery step executes processing for recovering a part of the currency values as electronic information from the balance of the currency values accumulated in the user account AC-U and transferring the part of the currency values to the electronic main depository EM. When the general account AC-C is managed in the account management step, the currency value recovery step executes processing for recovering a part of the currency values as electronic information from the balance of the currency values accumulated in the general account AC-C and transferring the part of currency values to the electronic main depository EM.

<Granting and Recovering Step: Steps S102 and S104 of FIG. 4>

The granting and recovering step executes the grant of a predetermined amount of currency values as electronic information by the currency value granting step upon a lapse of a predetermined grant period, and the recovery of a predetermined amount of currency values as electronic information by the currency value recovery step upon a lapse of a predetermined recovery period.

The processing (the processing shown in the flowchart of FIG. 4) including each of the steps mentioned above is executed by, for example, the computer of the management server 100. The flow of the processing is as follows.

First, in a state where the management of the account has been performed by the account management unit 111 (step S101), whether or not the grant period has elapsed is determined by the account management unit 111 (step S102). When grant period has elapsed, processing for granting the predetermined amount of currency values as electronic information to the user account AC-U by the currency value granting unit 112 is performed.

Next, whether or not the recovery period has elapsed is determined by the account management unit 111 (step S104). When the recovery period has elapsed, processing for recovering a part of currency values as electronic information from the balance of the currency values accumulated in the user account AC-U or the general account AC-C and transferring the part of the currency values to the electronic main depository EM is performed by the currency value recovery unit 113 (step S105).

Next, it is determined whether or not to continue the system (step S106), and in the case of continuing the system, the processing returns to step S102, and the subsequent processing is repeated.

Here, the recovery period shown in step S102 may be set to the same number of days as the grant period shown in step S104, and the date when the recovery processing is performed by the currency value recovery unit 113 shown in step S103 may be different from the date when the grant processing is performed by the currency value granting unit 112 shown in step S105. Thereby, the grant and recovery of the currency values with respect to the user U are performed on different days at regular intervals, and a cycle of the currency value circulation is constructed.

Further, the recovery period shown in step S102 may be set to a different number of days from the grant period shown in step S104. Thereby, the concentration of the currency values on the date of use can be eased, and it will be easier to activate economic activities.

Further, the grant by the currency value granting unit 112 shown in step S103 may be performed for each user account AC-U at a fixed amount, and the recovery by the currency value recovery unit 113 shown in step S105 may be performed at a fixed rate to the balance of the currency values accumulated in each account. Thereby, the currency values as the investment in the life of user U is regularly granted, and at the same time, the currency values at a fixed rate to the balance of all accounts, that is, the user account AC-U and the general account AC-C, is regularly recovered, which promotes the circulation of the currency values and the currency values are redistributed in the direction of reducing the gap in the holding amount of the currency values.

Further, the currency value management program may cause a computer (typically, terminal 300) to execute the following steps.

<Transfer Instruction Receiving Step: Steps S201 to S202 of FIG. 5(a)>

The transfer instruction receiving step performs the processing for receiving the value transfer instruction of at least any of the above-mentioned (1) to (4) and transmitting the instruction to the management server 100 via the network N.

The processing (the processing shown in the flowchart of FIG. 5(a)) including each of the steps mentioned above is executed by, for example, the computer of the terminal 300. The flow of the processing is as follows.

First, the value transfer instruction is received by the currency value transfer instruction unit 311 of the terminal 300 (step S201).

Next, the received value transfer instruction is transmitted from the communication unit 303 of the terminal 300 to the management server 100 via the network N (step S202).

Further, the currency value management program may cause a computer (typically, management server 100) to execute the following steps.

<Currency Value Transfer Step: Steps S301 to S302 of FIG. 5(b)>

The currency value transfer step executes processing for transferring the currency values between the accounts based on the value transfer instruction of at least any of the above (1) to (4). For example, the value transfer instruction sent from the terminal 300 via the network N is received, and the processing for transferring the currency values as electronic information between the accounts based on the value transfer instruction is executed.

That is, the processing (the processing shown in the flowchart of FIG. 5(b)) including each of the steps mentioned above is executed by, for example, the computer of the management server 100. The flow of the processing is as follows.

First, for example, the value transfer instruction transmitted from the terminal 300 via the network N is received by the communication unit 105 of the management server 100 (step S301), and the received value transfer instruction is sent to the account management unit 111.

Next, the account management unit 111 of the management server 100 performs the processing for transferring the predetermined amount of currency values between the accounts based on the value transfer instruction sent from the terminal 300 (step S302).

Next, a specific example of the processing of the currency value management program according to the present embodiment will be described.

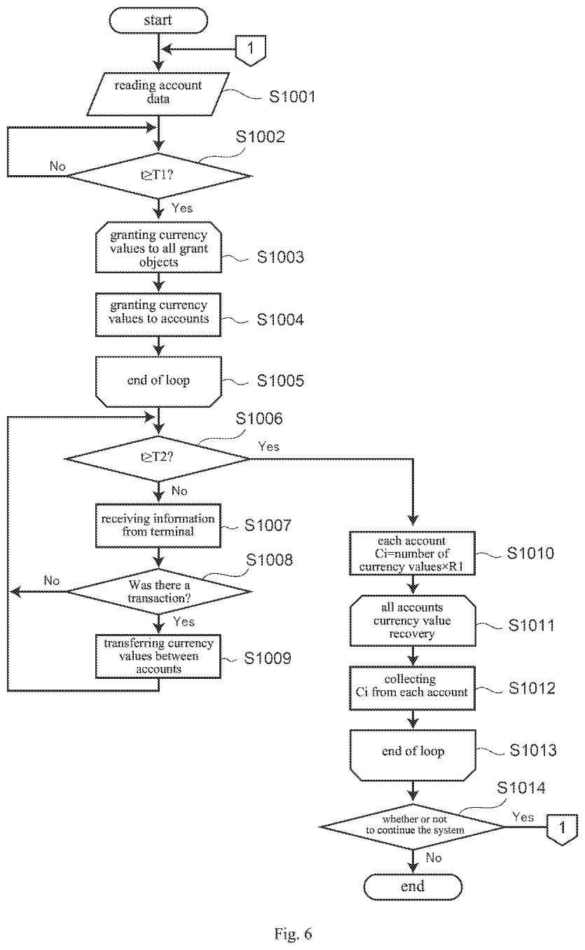

FIG. 6 is a flowchart showing a specific example of the processing for granting and recovering currency values.

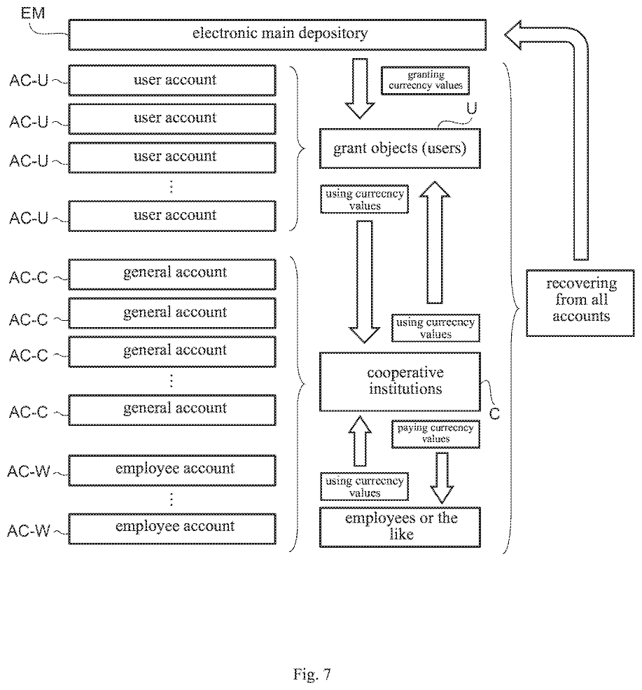

FIG. 7 is a conceptual diagram of the flow of accounts and currency values.

First, in order for the currency value management system 1 to function, accounts dedicated to this currency values are opened in advance. The accounts to be opened are the user accounts AC-U, the general accounts AC-C and the electronic main depository EM.

As shown in FIG. 7, first, the electronic main depository EM is created (opened), and the user accounts AC-U are opened within a fixed number of currency value grant objects, that is, the users U. Further, cooperative institutions C such as companies in which the currency values are used for exchanging goods and services are recruited and general accounts AC-C corresponding to those institutions are opened.

Here, as the attributes of the accounts, broadly speaking, accounts to which the currency values are granted from the electronic main depository EM (grant object accounts), and accounts to which the currency values are not granted from the electronic main depository EM (non-grant object accounts) can be mentioned.

The user U, who is the grant applicant, is the grant object, and is typically an individual (including a sole proprietor), but may be a corporation (public institution, organization, group, company, shop, etc.). The user accounts AC-U opened for the user U belong to the grant object accounts.

The cooperative institution C is a non-grant object, and is typically a corporation (public institution, organization, group, shop, etc.), but may be an individual (including a sole proprietor). The general accounts AC-C opened for the cooperative institution C belong to the non-grant object accounts.

Further, for example, a company, which is a cooperative institution C, may open accounts (employee accounts AC-W) for paying currency values as salaries, bonuses or the like (hereinafter, referred to as salaries or the like) from the company (cooperative institution C) for its employees, staff, bank clerks, or the like (hereafter, referred to as employees or the like).

The employees or the like are either non-grant objects or grant objects. If the employees or the like are non-grant objects, the employee accounts AC-W are non-grant object accounts. On the other hand, if the employees or the like are grant objects, the employee accounts AC-W are grant object accounts. In the present embodiment, a case where the employee or the like are non-grant objects and the employee accounts AC-W are non-grant object accounts will be described as an example.

It is to be noted that, in the present embodiment, various accounts are given names for convenience of explanation, but on the database of the present system, each account belongs to either the grant object accounts or the non-grant object accounts regardless of the name.

Further, in the operation of the present system, it is possible to set whether to allow one individual or one corporation to open only one account or to open a plurality of accounts. In either case, the attribute of the account belongs to either the grant object accounts or the non-grant object accounts. In addition, the account management unit 111 can change the attribute of the account.

The account is opened by being registered in, for example, the database server 200 by the processing of the account management unit 111. It is to be noted that, there may be any number of cooperative institutions C, but for example, sales companies of daily necessaries, grocery stores, supermarkets and the like where the grant applicants of currency values (users U) and the employees or the like can purchase with the currency values granted every month, public institutions, and banks, etc. are suitable.

Assuming that various accounts have been opened as described above, the processing shown in the flowchart of FIG. 6 is executed by the management server 100.

First, the account data is read (step S1001), then whether or not a predetermined time (referred to as T1) has elapsed is determined (step S1002), and when the time T1 has elapsed, a loop of granting a predetermined amount of currency values as electronic information from the electronic main depository EM to the user account AC-U of each grant applicants of currency values is executed (steps S1003 to S1005).

Next, after the loop of granting the currency values is completed, while monitoring the elapse of a previously designated time (referred to as T2) (step S1006), the information is received from the terminal 300 when the currency values are used for the transaction of buying and selling goods (step S1007), and the currency values are transferred between the accounts accordingly (steps S1008 to S1009). It is to be noted that, the processing for granting the currency values to the employee accounts AC-W as salaries or the like from the cooperative institution C to the employees or the like is also performed by steps S1007 to S1009. The timing of grant depends on the regulations of each cooperative institution C.

When the time of T2 has elapsed (Yes in step S1006), the currency values number (balance) of each account at that time is multiplied by the previously designated recovery rate R1, and the recovery amount Ci (i is each account) of each account is calculated (step S1010). Subsequently, a loop for recovering the amount of currency values corresponding to Ci from each account is executed to recover the amount (steps S1011 to S1013), and the amount of the currency values corresponding to R1 in the total amount is returned to the electronic main depository EM. Then, it is determined whether or not to continue the system (step S1014), and if it continues, the processing returns to step S1001 and the subsequent processing is repeated.

It is to be noted that, in the case of continuing the system, when the determination in step S1002 is No (when the time t1 has not elapsed), the processing of steps S1007 to S1009 may be included. That is, in the continuation of the system, it may be possible to transfer the currency values between the accounts by transaction before the grant of the currency values.

Such a system of grant and recovery of currency values is the core technology of the present disclosure, and the circulation of currency values is promoted by repeating the grant and recovery of currency values. It is a system that plays the role of the heart that circulates the currency which is the blood of society, starting from the electronic main depository EM, and has a very large economic revitalization effect, but the operating expenses of the system itself can be minimized by automation.

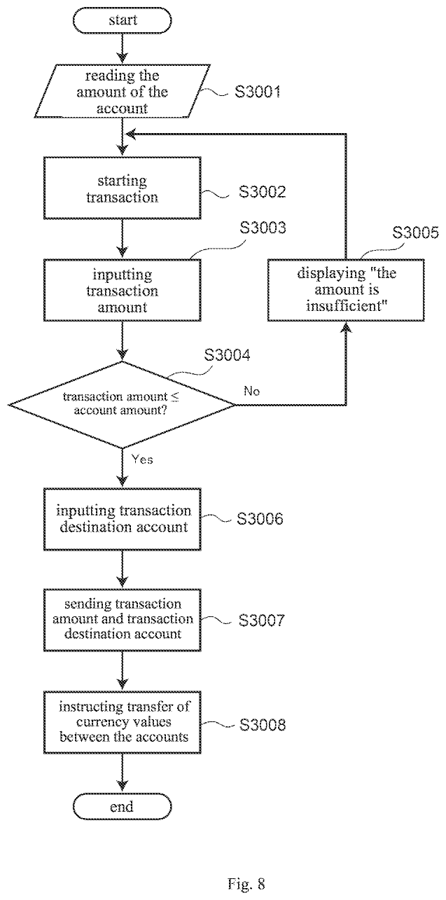

FIG. 8 is a flowchart showing a specific example of processing in a transaction based on currency values.

The processing shown in the flowchart of FIG. 8 is executed by the terminal 300.

When a currency value holder uses the granted currency values to purchase goods and services, the terminal 300 owned by the holder transmits the transaction information to the management server 100 side.

First, the terminal 300 reads the amount (balance of the currency values) of the account (user account AC-U, general account AC-C, employee account AC-W) specified by the terminal (step S3001). When the transaction is started (step S3002), the input of the amount (the amount of the currency values corresponding to the amount) is requested (step S3003), and whether the transaction amount can be paid with the total amount of the currency values (balance) in the account (user account AC-U, general account AC-C, employee account AC-W) (whether or not transaction amount≤account amount) is confirmed (step S3004).

When the payment is not possible in this confirmation (No in step S3004), a display such as “Insufficient amount” is displayed and the processing returns to step 53002. On the other hand, when the payment is possible in this confirmation (Yes in step S3004), the input of the information of the transaction destination account is requested (step S3006). After reading this information, information of the transaction amount and the transaction destination account is transferred from the terminal 300 to the management server 100 via the network N (step S3007), and the transfer of the currency values between the accounts is instructed (step S3008).

The currency value management system 1 operates as follows by the processing according to the flowchart shown in FIG. 6 and FIG. 8.

First, a predetermined amount of currency values are granted as electronic information from the electronic main depository EM to the user account AC-U of the currency value grant applicant (user U) of the. The currency values are not granted from the electronic main depository EM to the general account AC-C of the cooperative institution, the employee account AC-W, and the electronic main depository EM. It is to be noted that the currency values are paid as a salary from the general account AC-C to the employee account AC-W, and the currency values are transferred between the accounts except the electronic main depository EM.

Next, the transfer of currency values as follows is performed until a predetermined amount of currency values are next granted from the electronic main depository EM to the user account AC-U.

That is, the currency value grant applicant (user U) uses the granted currency values to purchase goods and services from cooperative institutions such as companies, stores and the like. At that time, the currency values as consideration for purchase of goods and services is transferred as electronic information from the user account AC-U to the general account AC-C of the cooperative institution C.

In addition, the cooperative institution can purchase goods and services from another cooperative institution. In this case, the currency values are transferred as electronic information from the institution account (one institution account) AC-C of the supplier of goods and services to the institution account (other institutional account) AC-C of the consumer. In addition, the cooperative institution can pay the currency values as a salary to the employee or the like. In this case, the currency values corresponding to the salary is transferred as electronic information from the general account AC-C of the cooperative institution to the employee account AC-W or the user account AC-U.

The employee or the like who has gained the currency values can purchase goods and services from cooperative institutions. In this case, the currency values corresponding to the consideration of the goods and services is transferred as electronic information from the employee account AC-W of the employee or the like or the user account AC-U to the general account AC-C of the cooperative institution.

In addition, it is also possible to transfer the currency values between users U, for example, in individual sales. In this case, currency values are transferred as electronic information from one user account AC-U or employee account AC-W to another user account AC-U or employee account AC-W.

In this way, the currency values are transferred as electronic information among all the accounts shown in FIG. 7.

After that, at a stage when the predetermined time has elapsed, the currency values are recovered from all the accounts of the user accounts AC-U, the general accounts AC-C and the employee accounts AC-W, for example, at a fixed rate to the balance and transferred to the electronic main depository EM as electronic information.

The recovered currency values can be used for the next grant. In this way, it is possible to construct a circulation system of currency values.

### (Application Example)

Next, application examples will be described.

### <1. When Non-Financial Companies Performs Grant and Management of Currency Values as Points>

A company (non-financial company) that executes the grant of points, which are currency values, prepares the above-mentioned currency value management system 1, determines and recruits a fixed number of point grant applicants, and at the same time, recruits cooperative institutions such as companies that will use the points for exchanging goods and services. The management server 100 opens an electronic main depository EM, and an account dedicated to points for each of the point grant applicants, the cooperative institutions, and the employees of the cooperative institutions. In addition, application software (so-called app) for using points is installed in each terminal such as a smartphone to make a terminal 300.

For example, in terms of points, which are the currency values, the correspondence ratio between the yen, which is the official currency of Japan, and points is 1:1. A predetermined amount (for example, 30,000 points) will be granted to the point grant applicant, and the fixed price in yen will be paid as it is in “points” for the sale of goods and services at the cooperative institution. A terminal will be prepared at each sales floor, and points will be paid by the point holder.

After the points are granted, a fixed rate (for example, 1%) is set after a predetermined period, for example, four weeks after the grant, and points for the above-set rate will be recovered as electronic information from the balance of all accounts (all accounts of the user accounts AC-U, the employee accounts AC-W and the general accounts AC-C). Since the points are reduced in this way, the points are circulated spontaneously because the use is promoted to use the points before they are running out. In addition, even if the points are not used by the point holder and the points are stagnated and precipitated in the account, they can be forcibly circulated by recovery.

It is to be noted that the point grant execution company and its employees can also create their own grant object accounts and become grant objects.

### <2. When a Financial Institution Performs Point Grant>

A financial institution, which implements point grant, for example, a bank prepares the above-mentioned currency value management system 1 in the server of the bank, and recruits point grant applicants, cooperative institutions and their employees in the same manner as in the above application example 1. The management server 100 opens a bank account AC-B in the account database (for example, database server 200) in addition to the user accounts AC-U, the general accounts AC-C, the employee accounts AC-W and the electronic main depository EM. No currency value is granted to the bank account AC-B from the electronic main depository EM. Therefore, the bank account AC-B is a non-grant object account. It is to be noted that a plurality of bank accounts AC-B may be provided. The bank selects bank employees (bank clerks) to whom salaries are paid in points and opens accounts (employee accounts AC-W).

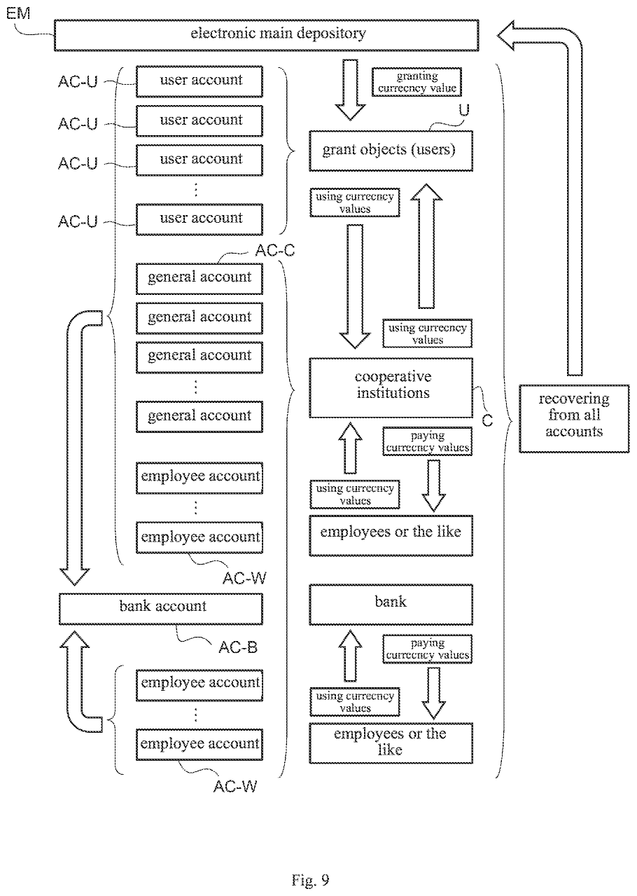

An image of the accounts and the point circulation in this case is shown in FIG. 9. When recovering the points, a fixed rate (for example, 1%) for recovery is set, and points for the fixed rate is recovered as electronic information from the balances of all of the user accounts AC-U, the employee accounts AC-W and the general accounts AC-C, and returned to the electronic main depository EM, which is the starting point of the currency value circulation. In addition, at the same time as recovering and returning to the electronic main depository EM, a fixed rate (for example, 1%) is set as the fee required for the operation of the bank and the preservation of the points, and points for the fixed rate are collected as electronic information from the balances of all of the user accounts AC-U, the employee accounts AC-W and the general accounts AC-C and transferred to the bank account AC-B (general account AC-C). It is to be noted that the fee for bank operation will not be collected from the bank account AC-B.

The bank can use these points to purchase goods and services at other cooperative institutions and to pay salaries to bank employees. It is to be noted that as a point user, 1% will be also recovered from the bank account and the employee account to the electronic main depository Em without exception. Therefore, points will not be stagnated and precipitated in the bank account indefinitely.

When a financial institution becomes a grant implementation company, in this way, in addition to the circulation in the whole society with the electronic main depository EM as a center, the circulation within the bank with the bank account AC-B as a center is also implemented. Therefore, at the time of recovery, the point holders are recovered (collected) at a rate of 2% in total, so that the use is also promoted and the points are spontaneously circulated. Further, in a bank, fee income corresponding to the holding amount of the points can be obtained, so that it is possible to operate even if it is free of charge for transferring such as transaction regrading points, and the use of points (transfer between accounts) can be promoted. From the view point of the user, it is easy to accept that it is not necessary to pay the transfer fee every time, and the fee amount of “1% of the balance at the time of collection” does not change no matter how many times the bank is used, so that it is close to the “fixed fee amount system”. Further, the maintenance cost of point deposits can be secured without relying on loans. For this reason, the operation of bank becomes a profit model that does not rely on loans, and the driving force for increasing loans, which was the fate of the conventional bank operation, can be reduced, contributing to the suppression of economic disparity in society.

Further, by repeating grant→recovery→grant→recovery→ . . . of points, the points in the society can be forcibly circulated and economic activities can be stimulated.

Here, it is considered that when the number of point grant applicants increases and the points are distributed in the whole society, the surplus points will begin to be stagnated in the relatively wealthy people. In other word, even if a recovery of fixed rate is performed every month, the points amount of (grant amount/recovery rate) can be accumulated up to the upper limit (in the example described later, when the grant amount is 30,000 points and the recovery rate is 1%, the upper limit amount is 3 million points). Further, the company, which becomes the cooperative institution, may also obtain a larger currency values amount than the transaction during the recovery period of one month. In this case, an interest-free economy can be established by lending the surplus points via banks.

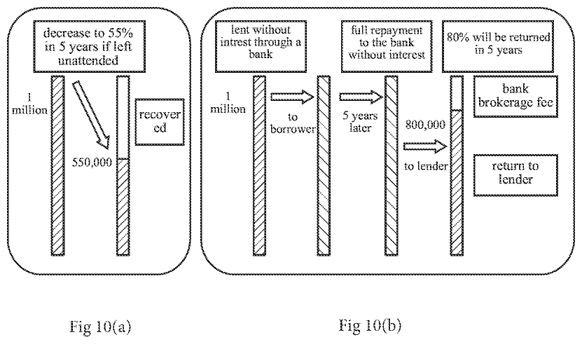

FIG. 10 is a schematic diagram illustrating the establishment of an interest-free economy.

First, as shown in FIG. 10(a), considering only the surplus points, the surplus points will be reduced nearly by half in five years by the recovery of 1% every month.

Then, as shown in FIG. 10(b), the points are lent without interest through a bank. The borrower will repay the entire amount to the bank in five years without interest. If the bank sets the fee at 20%, 80% will be returned to the lender. As shown in FIG. 10(b), considering that the surplus points will be reduced nearly by half in five years if they are left unattended, it is advantageous to lend the points even without interest. Further, when the bank fee is set to 10%, it is possible to lend the points on the condition that the borrower repays at a negative interest rate of 10%, that is, repays 90%.

Banks get a new business model of mediating between those who want to lend surplus points and those who want to borrow the shortage of funds. In this case, deposit creation is not performed and the points in society do not increase. By this method, it is possible to shift from an interest-bearing economy to an interest-free economy. Further, it is possible to obtain the effect of circulating the stagnated points by lending the stagnated points to individuals or companies that need the shortage of funds.

### <3. When a Public Financial Entity Grants and Manages Currency Values as a Regional Currency>

In an application example in which a public financial entity grants a regional currency, the financial entity issues a regional currency with funds obtained from a main bank (or the central bank if the region is a country) in an indefinite and interest-free loan. Similar to the previous application example, a currency value management system 1 (regional currency management system) based on the regional currency is prepared in the bank, and regional currency grant objects (for example, all adults) are determined.

Further, at the same time, cooperative institutions such as companies in which the regional currency is used for exchanging goods and services are recruited in the region. The management server 100 also prepares a bank account AC-B in the account database (for example, database server 200) in addition to the user accounts AC-U, the general accounts AC-C, the employee accounts AC-W and the electronic main depository EM. The bank account AC-B is a non-grant object account. An application software (so-called app) is installed in the terminal 300.

First, a fixed amount of regional currency (for example, 30,000 units of currency) is granted to grant objects (for example, all adults). If transactions for selling and buying in regional currency are carried out within the region and are further paid to employees as salaries, the regional currency will be distributed and circulated in the regional society.

Next, after a predetermined period of time (for example, four weeks from the grant) has elapsed, a fixed rate (for example, 1%) is set as the regional currency tax, and the regional currency for the fixed rate is collected as electronic information from the balances of all the user accounts AC-U, the employee accounts AC-W and the general accounts AC-C and returned to the electronic main depository EM of the financial entity. At the same time, a fixed rate (for example, 1%) is set for fees of bank operation and regional currency maintenance cost, and the regional currency for the fixed rate is collected as electronic information from the balances of all the user accounts AC-U, the employee accounts AC-W and the general accounts AC-C and transferred to the bank account AC-B. It is to be noted that the fee for bank operation will not be collected from the bank account AC-B. When there are multiple banks, the fee rate may vary from bank to back. In that case, the individual user account AC-U is opened separately in a plurality of banks. The bank fee will be collected only from the account of the own bank.

In this way, by regularly paying a fixed amount and collecting at a fixed rate, for example, once a month, it is possible to forcibly circulate the local currency within the region. If a fixed amount is paid, it can be distributed to everyone. If it is collected at a fixed rate, it will be recovered according to the amount of the possessed regional currency, and it will be possible to curb economic disparity by regularly redistributing the regional currency.

The currency value management system 1 of “fixed amount payment and fixed rate collection” of this regional currency has the following advantages.

### <Cost of Currency Circulation is Almost Zero>

If a currency value management system 1 (regional currency management system) and a terminal 300 are prepared as initial investment, the system automatically performs the fixed amount payment and the fixed rate collection according to a programmed procedure, so the operating expenses are minimized.

### <Reduction of Economic Disparity>

Since the currency value management system 1 (currency value circulation management system) plays the role of the heart that forcibly circulates the regional currency without precipitating in the wealthy class, it is possible to suppress the economic disparity among people.

### <Economic Revitalization>

The regional currency paid in a fixed amount is a regular “investment” in the life of the person (user U) to whom the regional currency is granted. The currency spent on investment becomes new income for others, which can greatly revitalize the economy.

### <The Total Amount of Currency can be Constantly Grasped>

Since only the digitized currency values are used, it is possible to constantly grasp the total amount of the currency values.

### <Economic Measures>

Since the economic effect of this investment is equal to the total transaction amount (=the total amount of transfer of the “currency values”), it is easy to grasp the economic effect of this investment. In addition to the above total amount of currency, economic measures can be taken by adjusting the circulation.

### <Work Sharing Expansion>

The regional currency paid in a fixed amount becomes the basic income of the regional residents and enables work sharing. Further, the economy is revitalized and the employment is promoted by the promotion of the currency circulation. Since it is a circulating regional currency, the financial resources for basic income are also secured.

<Countermeasures against the Falling Birthrate>

Since it is an investment in the lives of regional collective members, it can be a countermeasure against the falling birthrate. Especially if children are included in the payment target, the effect is great.

Here, effects 1 to 8 corresponding to the above problems 1 to 8 by the currency value management system 1 and the currency value management program according to the present embodiment will be described.

### <Effect 1: Circulation of Currency Values (Points)>

The present embodiment has two effects of “forced circulation” and “spontaneous circulation” in the circulation of currency values as described below.

The currency values are forcibly circulated (forced circulation) in the real economy by granting the currency values, recovering it at a specified rate after a specified period, and sending it to the grant again.

Since the currency values are recovered (collected) after a predetermined period of time and decreases, it becomes “depreciated currency values asset”, and voluntary use before it decreases is promoted. That is, the currency values holders voluntarily circulate the currency values in the real economy (spontaneous circulation), which has the same effect as Gesell's free money (see Non-Patent Document 4).

The present embodiment plays the role of the heart in the society to evenly distribute the currency in the whole society and suppress the unlimited stagnation and precipitation of the currency values due to the above two types of powerful circulation functions. Further, due to the fixed amount supply and the fixed rate collection, the collection will respond to the amount of currency values possession while the supply is equal, and since a large amount will be collected from the wealthy class, the currency values will be redistributed in the direction of reducing the economic disparity of the society, and the economic disparity can be reduced.

### <Effect 2: Improvement in Business Conditions of Banks>

When a bank makes a contract with a currency value granting institution and takes charge of currency values preservation, the bank can collect a certain rate as a fee independently of the total recovery by the electronic main depository EM. By using this as the wages of the bank employees, it is possible to form a circulation of currency values starting from the bank, and it becomes possible to manage the bank without relying on loans. This reduces the driving force for the increase in loanees and contributes to the suppression of economic disparity of the society.

Further, in the bank, the bank transfer fee and the like can be made free and the currency circulation in the society can by activated by receiving the management fee of currency values in a lump sum.

### <Effect 3: Government Budget Deficit Reduction>

If a regional currency is issued according to the present embodiment, the currency values granted to the private sector at the time of budget execution by the financial entity can build a mechanism to return the entire amount to the financial entity within a finite period, and can form a sustainable circulating currency. Further, Japanese yen can be recovered as tax and used for repayment of government bonds.

<Effect 4: Conversion from Interest-Bearing Economy to Interest-Free Economy>

In the present embodiment, if wealthy currency values holders continue to accumulate and hold surplus currency values, it will be recovered and decrease. For example, if 1% is recovered a month, it will be reduced nearly by half in five years. If the currency values are lent out without interest and repaid in 5 years, for wealthy currency values holders, the amount of currency values does not decrease even after 5 years, so it can be said that it is an advantageous operation compared to the case where it is left unattended. Accordingly, the surplus currency values can be collected at a bank and lent out under a contract to repay it without interest in five years. In this case, it is not lending of currency values (direct financing) by deposit creation of the bank, but lending (indirect financing) from the currency values holders through the bank, and the currency values disappears from the accounts of the currency values holders, and the currency values are transferred to the accounts of the borrowers. Therefore, the total amount of currency values in the society does not change.

Further, at the time of lending, if the bank lends the currency values under a contract to repay 90% of the lent currency values to the lender in five years, the borrower will repay the total amount to the bank in five years without interest, and the bank will repay 90% of it to the lender, so 10% of the lent amount can be used as the amount received by the bank. This is because for the wealthy currency values holders, if 90% is repaid in five years, this is a more advantageous operation than leaving the currency values unattended to reduce it by half. In this way, banks get new business conditions of indirect financing.

### <Effect 5: Suppressing Unemployment and Expanding Leisure by Promoting Work Sharing>

The currency value grant according to the present embodiment can be used as basic income in work sharing that shares labor demand. As science and technology develop and labor demand decreases, sharing low labor demand among workers can curb unemployment and allow each worker to expand their leisure time. At this time, since labor demand decreases, a decrease in wages, which is the consideration for labor, is inevitable, but if the currency values granted is used as the basic income, it is possible to compensate for the decrease. The mechanism of circulating currency allows workers to expand their leisure time, create new industries for their leisure time, and revitalize the economy. It is to be noted that since it is a circulating currency values, the financial resources for basic income are also secured.

### <Effect 6: Regular Economic Boost>

The currency value grant according to the present embodiment can be a regular economic measure. As shown in Table 1, various economic models have been proposed, but if the currency values are granted once a month, the economic wave caused by the circulating currency becomes a regular monthly economic stimulus measure and can contribute to a sustainable economy (see (4) in table 1). Since this economic measure is carried out by an automated system, it costs very little.

TABLE 1

| | Name of | | |
|---|---|---|---|
| | wave | Cycle | Cause of the cycle |
| (1) | Kondratieff | long-term | Investment in technological |
| | wave | wave | innovation development |
| | | about 50- | New technologies are developed |
| | | year cycle | every 50 years, investment increases |
| | | | and the economy is stimulated |
| (2) | Kuznets' | medium and | Construction investment |
| | wave | long-term | Buildings are rebuilt every 20 years, |
| | | wave about | investment increases and the |
| | | 20-year | economy is stimulated |
| | | cycle | |
| (3) | Juglar's | medium- | Capital investment |
| | wave | term | Companies buy new production |
| | | wave about | machines every 10 years, investment |
| | | 10-year | increases and the economy is |
| | | cycle | stimulated |
| (4) | Wave due to | periodic | Living investment |
| | circulating | vibration | Every month, the currency is paid to |
| | currency (the | (for | the household and the currency is |
| | present | example) | circulated. An alternative to (1)-(3). |
| | embodiment) | once a month | |

### <Effect 7: Easy Economic Effect Measurement and Economic Control>

By managing the digitized system, that is, the currency values as electronic information, the total transaction amount can be derived instantly. Therefore, it becomes easy to grasp the economic effect. The total amount of the currency values existing in society approaches (grant amount×number of persons)/recovery rate when it is granted and recovered once a month (see the following calculation model). Here, (monthly transaction total amount/total amount in society) is the usage rate of the currency values, so the total amount can be controlled by changing the grant amount or the recovery rate after grasping this usage rate by measuring the total transaction amount. Thereby, it will be easier to visualize the economy, and it will be possible to control the economy by changing the grant amount and the recovery rate.

<Effect 8: Currency Values with Deflation Resistance>

Under deflation, the economy is contracted because the prices of goods fall over time, which induces refraining from buying and causes stagnation of consumption. However, according to the present embodiment, if the currency values are left unattended, it will decrease due to recovery (collection), so that the use and distribution of currency will be promoted under deflation. Therefore, it can be said that the currency values according to the present embodiment has deflation resistance (see Non-Patent Document 1). At present, with the development of science and technology improving productivity in all industries, prices are inevitably falling. If the currency values according to the present embodiment are used, it is possible to benefit from the price reduction due to the development of science and technology without stagnation of the economy.

The total amount of currency values in society according to the present embodiment is very important for controlling the intensity of economic activity (economy), but this total amount gradually approaches a certain amount determined by three factors of grant amount, number of persons e, and recovery rate, and does not continue to increase indefinitely beyond this upper limit. The existence of this upper limit on the total amount is essential to prevent overheating of the economy. In the currency value management system according to the present embodiment, it is shown below by calculation that it is easy to design the total amount of currency values due to the above three factors.

### “Calculation Model”

Assuming a fixed amount payment and a fixed rate collection once a month, the total amount Zst of the currency values granted each month is expressed as the following formula 1 using the fixed grant amount Z1 and the number of persons N.

$$Zst = Z 1 \times N \qquad formula 1$$

On the other hand, the total amount Zct (m) of the currency values to be collected in the m-th month after the start of the fixed amount payment is expressed as the following formula 2 using the total amount Zt (m) of the currency values existing in society at the beginning of the m-th month and the rate R of the fixed rate collection.

$$Zct ( m ) = ( ZT ( m ) + Zst ) \times R \qquad formula 2$$

Therefore, at the end of the m-th month, the total amount Zt (m+1) of the currency values existing in society increases by Zst from the previous month and then decreases by Zct (m), so it can be written as the following formula 3.

$$\begin{matrix}ZT ( m + 1 ) = ZT ( m ) + Zst - Zct ( m ) \\ = ZT ( m ) + Zst - ( ZT ( m ) + Zst ) \times R \\ = ( ZT ( m ) + Zst ) \times ( 1 - R )\end{matrix} \qquad formula 3$$

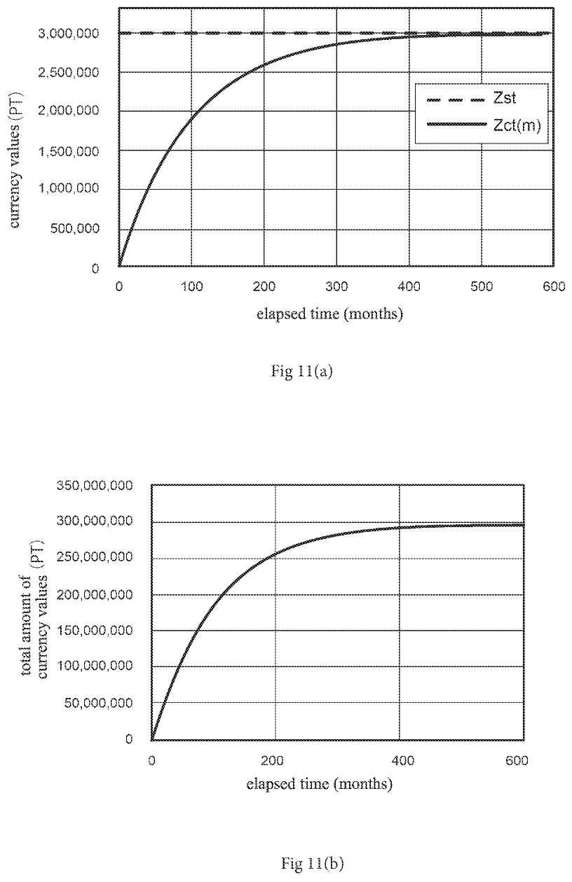

FIG. 11(a) shows the changes in Zst and Zct (m) when the unit of the currency values is [point: PT], Z1=30,000 [PT], N=100 persons, and R=1%. It can be seen that Zct gradually approaches Zst. When Zst=Zct (m), the total amounts of supply and recovery coincide with each other, the fluctuation of the currency values in the whole society becomes zero, and the total amount ZT (m) of the whole society reaches the stationary value ZTs.

The value of Zts can be derived as shown in the following formula 4.

$$Zst = Z c t ( m ) = ( Z T s + Z s t ) \times R \qquad formula 4$$

Here, ZTs»Zst is used,

Zst=ZTs×R

∴ZTs=Zst/R=(Z1×N)/R

FIG. 11(b) shows a state in which the total amount of the currency values existing in society approaches (grant amount×number of persons)/recovery rate when it is granted and recovered once a month. Similar to FIG. 11(a), when the grant amount is 30,000 [PT], the number of grant target persons is 100, and the recovery rate is 1%, the total amount of the currency values existing in society is (30,000×100)/0.01[PT] and gradually approaches 300 million [PT].

By using the currency value management system 1 according to the present embodiment, it is possible to easily design the value of the total amount of the currency values distributed in the society based on the grant amount, the number of persons, and the recovery rate.

Further, even when the grant applicant saves the granted currency values without using it at all, a stationary value is reached when the grant amount and the recovery amount coincide with each other. If the supply amount is 30,000 [PT] and the recovery rate is 1%, when 3,000,000 [PT] is reached, the monthly supply amount becomes the same as the recovery amount and does not increase any more. That is, even for the grant applicant, the amount that can be accumulated only by grant is limited to (grant amount/recovery rate), and the endless precipitation of currency values can be suppressed.

At the same time, this fact means that a certain amount of savings is possible with this currency values. There may be cases where a certain amount of currency values granted is desired to be saved for any unexpected situation, illness, or future consumption. The upper limit is 3,000,000 [PT] in the above case.

It is to be noted that even if all the 100 million people of Japan have accumulated the above 3,000,000 [PT], the total is 300 trillion [PT]. This total amount is 300 trillion yen when it is converted into yen as it is, which is an amount comparable to GDP (about 500 trillion yen) and the current total amount of currency in Japan (over 1000 trillion yen), and is a sufficiently feasible amount as the total amount of currency values.

### (Application Example)

In the currency value management system 1 and currency value management program according to the present embodiment, since the currency values are managed as electronic information, the following applications are possible.

### <Big Data Acquisition>

By using the currency value management system 1 according to the present embodiment, it is possible to automatically record the information of all transactions in the database server 200 for each account. At this time, various big data can be acquired by collecting the attributes of the grant object and the non-grant object in advance and linking them to each account.

For example, if attributes such as address, age, gender, occupation, marital status, child status and the number of children are linked to the account, it is possible to acquire the total transaction amount (that is, economy effect) and the currency usage rate by region, check the seasonal fluctuations, compare the usage rates by age and gender, and check the fluctuations by day of the week. Further, it is also possible to extract by industry, such as differences in economic behavior based on the child status and the regional characteristics. The acquisition of big data is a feature unique to the currency value management system 1 according to the present embodiment in which transactions are exchanges of electronic information, and daily economic activities can also be visualized.

### <Unique Identification Information of Currency Values>

The management server 100 can give and manage identification information (unique number, unique symbol, etc.) unique to the currency values. That is, the management server 100 may grant and manage identification information unique to the currency values for each predetermined unit (for example, the minimum unit or the granting unit) of the currency values to be provided.

For example, when currency values of 30,000 [PT] are regularly granted to a person X who is one of the users U, identification information is granted to each of the granted currency values of 30,000 [PT]. Thereby, 30,000 kinds of identification information are granted to the currency values of 30,000 [PT] and managed in the database. The management server 100 records in a database the information of the person X who is the user U to whom the currency values has been granted, the date and time of the grant, and the like for each unique identification information. The management server 100 may grant one type of identification information to the currency values of 30,000 [PT].

### <Traceability of Currency Values>

The management server 100 may manage the distribution channel and the distribution history of the currency values based on the identification information granted to the currency values. For example, when the person X, who is the user U to whom the currency values has been granted, used the currency values to purchase merchandise, the management server 100 records and manages the user information of the currency values, transfer date and time, transfer destination information, use target (information on purchased merchandise and services) and the like in association with the identification information granted to the currency values used when the merchandise is purchased. The management server 100 records such records to accumulate each time the currency values are used. Thereby, by specifying the identification information, it is possible to grasp the distribution channel and the distribution history of the currency values associated with the identification information.

### <Order of use of Currency Values>

The management server 100 may manage the order of use of the currency values based on the identification information granted to the currency values. For example, when a predetermined amount of currency values are accumulated in the user account AC-U of a person X, who is the user U, the management server 100 can grasp the date and time (reception date and time) of transferring to the user account AC-U of the person X from the identification information granted to each of the currency values of the user account AC-U. When the person X uses the currency values in the user account AC-U to purchase merchandise, the management server 100 may manage to use the currency values from that with the old reception date and time among the currency values in the user account AC-U of the person X. Thereby, the currency values with the old reception date and time is used first, and it becomes easy to grasp the stagnation status, the turnover rate and the like of the currency values.

### <Grasp of Circulation Period of Currency Values>

The management server 100 may manage the circulation period of the currency values based on the identification information granted to the currency values. For example, after the currency values with the identification information is transferred from the electronic main depository EM to the user account AC-U, the management server 100 can grasp the circulation period of how long it takes to return to the electronic main depository EM for each currency values.

### <Grasp of Stagnation Period>

The management server 100 can grasp the stagnation period of the currency values for each user U based on the identification information granted to the currency values. For example, the currency values granted to the user account AC-U of a person X, who is the user U, is managed by the identification information by the management server 100. The management server 100 calculates the period until the currency values granted to the user account AC-U of the person X is transferred from the user account AC-U to another account as the stagnation period. The management server 100 can grasp the stagnation period of the currency values of the person X by calculating the average stagnation period for the user account AC-U, for example.

### <Setting of Recovery Rate According to Stagnation Period>

The management server 100 may perform management for setting the recovery rate according to the stagnation period for each user U as described above. For example, a user U having a longer stagnation period may have a higher recovery rate, and a user U having a shorter stagnation period may have a lower recovery rate.

### (Currency Value Management Method)

The operation of the currency value management system 1 and the currency value management program according to the present embodiment can be specified as a currency value management method.

That is, the currency value management method is a method that manages the flow of currency values corresponding to the monetary values, including:

an account management process of managing a user account with which electronic information relating to the currency values of each user is associated, and an electronic main depository with which electronic information at least relating to the currency values used for granting is associated;

a currency value granting process of granting currency values as electronic information to the user account; a currency value recovery process of recovering a part of currency values as electronic information from the balance of the currency values accumulated in the user account and transferring the part currency values to the electronic main depository; and

a grant and recovery process of performing the grant of a predetermined amount of currency values as electronic information by the currency value granting process upon a lapse of a predetermined grant period, and the recovery of a predetermined amount of currency values as electronic information by the currency value recovery process upon a lapse of a predetermined recovery period.

### (Storage Medium Containing Currency Value Management Programs)

Further, currency value management program according to the present embodiment may be stored in a computer readable storage medium (DVD-ROM or the like).

That is, the computer readable storage medium is a medium for storing the currency value management program that manages the flow of the currency values corresponding to the monetary values, and stores in a computer:

an account management step of managing a user account with which electronic information relating to the currency values of each user is associated, and an electronic main depository with which electronic information at least relating to the currency values used for granting is associated;

a currency value granting step of granting currency values as electronic information to the user account;

a currency value recovery step of recovering a part of currency values as electronic information from the balance of the currency values accumulated in the user account and transferring the part currency values to the electronic main depository; and

a granting and recovering step of performing the grant of a predetermined amount of currency values as electronic information by the currency value granting step upon a lapse of a predetermined grant period, and the recovery of a predetermined amount of currency values as electronic information by the currency value recovery step upon a lapse of a predetermined recovery period.

Further, in the account management step, an institution account to which a predetermined amount of currency values are not granted as electronic information in the currency value granting step is further managed.

In the currency value recovery step, a predetermined amount of currency values may be recovered as electronic information from the balance of the currency values accumulated in each of the user account and the institution account, and transferred to the electronic main depository.

In addition, the management server 100 and the terminal 300 are connected via a network N.

The computer readable storage medium may further store a transfer instruction receiving step of receiving at least any of the following instructions by the terminal 300 and transmitting the instructions to the management server 100 via the network N:

an instruction of transferring a predetermined amount of currency values as electronic information from one user account to another user account;

an instruction of transferring a predetermined amount of currency values as electronic information from the user account to the institution account;

an instruction of transferring a predetermined amount of currency values as electronic information from the institution account to the user account; and

an instruction of transferring a predetermined amount of currency values as electronic information from one institution account to another institution account.

In addition, the computer readable storage medium may further store a currency value transfer step of performing at least any of:

processing for transferring a predetermined amount of currency values as electronic information from one user account to another user account;

processing for transferring a predetermined amount of currency values as electronic information from the user account to the institution account;

processing for transferring a predetermined amount of currency values as electronic information from the institution account to the user account; and

processing for transferring a predetermined amount of currency values as electronic information from one institution account to another institution account.

In addition, the currency value management program according to the present embodiment may be configured to be distributable via the network N.

As described above, according to the present embodiment, it is possible to provide a currency value management system and a currency value management program that suppress unlimited stagnation, precipitation and maldistribution of currency values and smoothly circulate the currency values in the market.

It is to be noted that although the present embodiment and the application examples (modification examples, specific examples) are described above, the present disclosure is not limited to these examples. For example, regarding the grant and the recovery of the currency values as electronic information, an example in which the recovery is performed once or multiple times with respect to one grant has been described, but the recovery may be performed once with respect to multiple times of grant. Further, with respect to each of the above-described embodiments or application examples thereof (modification examples, specific examples), appropriate additions, deletions of constituent elements, and design changes by those skilled in the art, as well as appropriate combinations of features of each embodiment are included in the scope of the present disclosure as long as the spirit of the present disclosure is included.

### POSSIBILITY OF APPLICATION FOR INDUSTRY

As described above, in the present disclosure, a currency value having a value equivalent to that of a currency can be suitably used not only for a point but also for a currency value using a virtual currency or an actual currency.

### EXPLANATION OF REFERENCE SYMBOLS

1 . . . currency value management system
100 . . . management server
101 . . . control unit
102 . . . storage unit
103 . . . input unit
104 . . . output unit
105 . . . communication unit
111 . . . account management unit
112 . . . currency value granting unit
113 . . . currency value recovery unit
200 . . . database server
201 . . . control unit
202 . . . storage unit
203 . . . communication unit
300 . . . terminal
301 . . . control unit
302 . . . input-output unit
303 . . . communication unit
310 . . . individual terminal
311 . . . currency value transfer instruction unit
320 . . . transaction terminal
A . . . management institution
AC-B . . . bank account
AC-C . . . general account
EM . . . electronic main depository
AC-U . . . user account
AC-W . . . employee account
C . . . cooperative institution
N . . . network
U . . . user

1. A currency value management system that manages flow of currency values as an alternative of official currency in response to monetary values, comprising a management server connected to a network, wherein the management server comprises:
an account management unit that manages an electronic main depository with which electronic information at least relating to currency values used for granting is associated, and a plurality of accounts comprising grant object accounts with which electronic information relating to currency values of each grant object to which the currency values are granted from the electronic main depository is associated and non-grant object accounts to which a predetermined amount of currency values are not granted as electronic information from the electronic main depository;
a currency value granting unit that grants currency values as electronic information from the electronic main depository to a grant object account; and
a currency value recovery unit that recovers a part of currency values as electronic information from a balance of currency values accumulated in all accounts comprising the grant object accounts and the non-grant object accounts and transfers the part of currency values to the electronic main depository,
wherein the account management unit controls:
grant of a predetermined amount of currency values as electronic information by the currency value granting unit upon a lapse of a predetermined grant period; and
recovery of a predetermined amount of currency values as electronic information from all accounts by the currency value recovery unit upon a lapse of a predetermined recovery period.

2. The currency value management system according to claim 1, wherein the account management unit manages a bank account corresponding to a grant implementation financial institution of the currency values and being one of the non-grant object accounts, and
the account management unit recovers a part of currency values as electronic information from a balance of currency values accumulated in all accounts comprising the bank account by the currency value recovery unit and transfers the part of currency values to the electronic main depository, and transfers a part of currency values from a balance of currency values accumulated in an account other than the bank account to the bank account as electronic information.

3. The currency value management system according to claim 2, further comprising a terminal connected to the management server via the network, wherein the terminal comprises a currency value transfer instruction unit that sends at least any of following instructions to the management server via the network:
an instruction of transferring a predetermined amount of currency values as electronic information from one grant object account to another grant object account;
an instruction of transferring a predetermined amount of currency values as electronic information from the grant object account to the non-grant object account;
an instruction of transferring a predetermined amount of currency values as electronic information from the non-grant object account to the grant object account; and
an instruction of transferring a predetermined amount of currency values as electronic information from one non-grant object account to another non-grant object account.

4. The currency value management system according to claim 2, wherein the account management unit controls at least any of:
processing for transferring a predetermined amount of currency values as electronic information from one grant object account to another grant object account;
processing for transferring a predetermined amount of currency values as electronic information from the grant object account to the non-grant object account;
processing for transferring a predetermined amount of currency values as electronic information from the non-grant object account to the grant object account; and
processing for transferring a predetermined amount of currency values as electronic information from one non-grant object account to another non-grant object account.

5. The currency value management system according to claim 1, wherein the recovery period has the same number of days as that of the grant period, and a date of recovery by the currency value recovery unit is different from a date of grant by the currency value granting unit.

6. The currency value management system according to claim 1, wherein the grant by the currency value granting unit is performed at a fixed amount for each grant object account, and the recovery by the currency value recovery unit is performed at a fixed rate to a balance of the currency values accumulated in each account.

7. A currency value management program that manages flow of currency values as an alternative of official currency in response to monetary values, making a computer execute steps of:
an account management step of managing an electronic main depository with which electronic information at least relating to currency values used for granting is associated, and a plurality of accounts comprising grant object accounts with which electronic information relating to currency values of each grant object to which the currency values are granted from the electronic main depository is associated and non-grant object accounts to which a predetermined amount of currency values are not granted as electronic information from the electronic main depository;
a currency value granting step of granting currency values as electronic information from the electronic main depository to a grant object account;
a currency value recovery step of recovering a part of currency values as electronic information from a balance of currency values accumulated in all accounts comprising the grant object account and the non-grant object account and transfers the part of currency values to the electronic main depository; and
a granting and recovering step of performing grant of a predetermined amount of currency values as electronic information by the currency value granting step upon a lapse of a predetermined grant period, and recovery of a predetermined amount of currency values as electronic information from all the accounts by the currency value recovery step upon a lapse of a predetermined recovery period.

8. The currency value management program according to claim 7, wherein in the account management step, a bank account corresponding to a financial institution that implements the grant of the currency values and being one of the non-grant object accounts is managed, and
in the currency value recovery step, a part of currency values are recovered as electronic information from a balance of currency values accumulated in all accounts comprising the bank account and transferred to the electronic main depository, and a part of currency values are transferred from a balance of currency values accumulated in an account other than the bank account to the bank account as electronic information.

9. The currency value management program according to claim 8, wherein a management server and a terminal are connected via a network, and
the computer further performs a transfer instruction receiving step of receiving at the terminal and transmitting at least any of following instructions to the management server via the network:
an instruction of transferring a predetermined amount of currency values as electronic information from one grant object account to another grant object account;
an instruction of transferring a predetermined amount of currency values as electronic information from the grant object account to the non-grant object account;
an instruction of transferring a predetermined amount of currency values as electronic information from the non-grant object account to the grant object account; and
an instruction of transferring a predetermined amount of currency values as electronic information from one non-grant object account to another non-grant object account.

10. The currency value management program according to claim 8, further comprising a currency value transfer step of performing at least any of:
processing for transferring a predetermined amount of currency values as electronic information from one grant object account to another grant object account;
processing for transferring a predetermined amount of currency values as electronic information from the grant object account to the non-grant object account;
processing for transferring a predetermined amount of currency values as electronic information from the non-grant object account to the grant object account; and
processing for transferring a predetermined amount of currency values as electronic information from one non-grant object account to another non-grant object account.

11. The currency value management program according to claim 7, wherein the recovery period has the same number of days as that of the grant period, and a date of recovery by the currency value recovery step is different from a date of grant by the currency value granting step.

12. The currency value management program according to claim 7, wherein the grant by the currency value granting step is performed at a fixed amount for each grant object account, and the recovery by the currency value recovery step is performed at a fixed rate to a balance of the currency values accumulated in each account.

13. A computer readable storage medium containing a currency value management program that manages flow of currency values as an alternative of official currency in response to monetary values, the program making a computer execute steps of:
an account management step of managing an electronic main depository with which electronic information at least relating to currency values used for granting is associated, and a plurality of accounts comprising grant object accounts with which electronic information relating to currency values of each grant object to which the currency values are granted from the electronic main depository is associated and non-grant object accounts to which a predetermined amount of currency values are not granted as electronic information from the electronic main depository;
a currency value granting step of granting currency values as electronic information from the electronic main depository to a grant object account;
a currency value recovery step of recovering a part of currency values as electronic information from a balance of currency values accumulated in all accounts comprising the grant object account and the non-grant object account and transfers the part of currency values to the electronic main depository; and p1 a granting and recovering step of performing grant of a predetermined amount of currency values as electronic information by the currency value granting step upon a lapse of a predetermined grant period, and recovery of a predetermined amount of currency values as electronic information from all the account by the currency value recovery step upon a lapse of a predetermined recovery period.

14. The computer readable storage medium according to claim 13, wherein in the account management step, a bank account corresponding to a financial institution that implements the grant of the currency values and being one of the non-grant object accounts is managed, and
in the currency value recovery step, a part of currency values are recovered as electronic information from a balance of currency values accumulated in all accounts comprising the bank account and transferred to the electronic main depository, and a part of currency values are transferred from a balance of currency values accumulated in an account other than the bank account to the bank account as electronic information.

15. The computer readable storage medium according to claim 14, wherein a management server and a terminal are connected via a network, the computer further performs a transfer instruction receiving step of receiving at the terminal and transmitting at least any of following instructions to the management server via the network:
an instruction of transferring a predetermined amount of currency values as electronic information from one grant object account to another grant object account;
an instruction of transferring a predetermined amount of currency values as electronic information from the grant object account to the non-grant object account;
an instruction of transferring a predetermined amount of currency values as electronic information from the non-grant object account to the grant object account; and
an instruction of transferring a predetermined amount of currency values as electronic information from one non-grant object account to another non-grant object account.

16. The computer readable storage medium according to claim 14, wherein the program further comprises a currency value transfer step of performing at least any of:
processing for transferring a predetermined amount of currency values as electronic information from one grant object account to another grant object account;
processing for transferring a predetermined amount of currency values as electronic information from the grant object account to the non-grant object account;
processing for transferring a predetermined amount of currency values as electronic information from the non-grant object account to the grant object account; and
processing for transferring a predetermined amount of currency values as electronic information from one non-grant object account to another non-grant object account.

17. The computer readable storage medium according to claim 13, wherein the recovery period has the same number of days as that of the grant period, and a date of recovery by the currency value recovery step is different from a date of grant by the currency value granting step.

18. The computer readable storage medium according to claim 13, wherein the grant by the currency value granting step is performed at a fixed amount for each grant object account, and the recovery by the currency value recovery step is performed at a fixed rate to a balance of the currency values accumulated in each account.
